(19) United States
(12) Patent Application Publication
(10) Pub. No.: US 2009/0313404 A1
(43) Pub. Date: Dec. 17, 2009

(54) APPARATUS FOR ACCESSING CONDITIONAL ACCESS DEVICE BY UTILIZING SPECIFIC COMMUNICATION INTERFACE AND METHOD THEREOF

(76) Inventor: Meng-Nan Tsou, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/139,507

(22) Filed: Jun. 16, 2008

(51) Int. Cl. G06F 13/42

(52) U.S. Cl. 710/71

(57) ABSTRACT

An apparatus for accessing a conditional access device, which utilizes an external communication interface for information transaction, is disclosed. The apparatus includes a host and an interface module. The host is utilized for receiving or transmitting information according to a specific communication interface. The interface module is coupled to the host and utilized for bridging the specific communication interface and the external communication interface. Another apparatus for accessing a conditional access device having a CPU interface/inband interface is disclosed. The apparatus includes a flash interface/serial interface and a data processing circuit. The data processing circuit is coupled to the flash interface/serial interface and utilized for receiving information outputted from the CPU interface/inband interface through the flash interface/serial interface or transmitting information to the CPU interface/inband interface through the flash interface/serial interface.

### BACKGROUND

The present invention relates to a television (TV) receiving scheme, and more particularly, to a system, an apparatus, and related method for accessing a conditional access device.

Please refer to FIG. 1. FIG. 1 is a diagram of a conventional conditional access system 100 when booting up a conditional access device, e.g. a POD (point of deployment) device 105. As shown in FIG. 1, the conditional access system 100 is also called a host and it usually includes a TV tuner 110, a demodulator 115, a QPSK transmitter 120, a QPSK receiver 125, a demultiplexer 130, and a CPU 135. The POD device 105 is referred as to a CableCard device. Initially, the conditional access system 100 enters PCMCIA mode and then the POD device 105 is booted up by the CPU 135 of the conditional access system 100 through a PCMCIA interface having 60 signal pins.

Once the POD device 105 is started, the conditional access system 100 enters POD mode to access the POD device 105. Please refer to FIG. 2. FIG. 2 is a diagram of the prior art conditional access system 100 when accessing the POD device 105 in POD mode. The CPU 135 executes an information transaction and communicates with the POD device 105 via 26 signal pins shown in FIG. 2 (these signal pins are usually known as a CPU interface). A video program is received by the TV tuner 110 and the received video program is then processed by the TV tuner 110 and demodulator 115. A transport stream T, is therefore outputted by the demodulator 115 to the POD device 105 via a parallel interface having 11 signal pins, which are comprised of eight data pins, one clock pin, one sink pin, and one valid pin. The POD device 105 descrambles/decrypts the transport stream T₁ to generate a transport stream T₂ into the demultiplexer 130 of the conditional access system 100. The demultiplexer 130 then demultiplexes the transport stream T₂ to generate program data, which will be processed by an AV decoder or other elements. Similarly, the transport stream T₂ is also transmitted via a parallel interface having 11 signal pins comprised of eight data pins, one clock pin, one sink pin, and one valid pin. These signal pins for transmitting the transport streams T₁ and T₂ are also known as an inband (INB) interface. In addition, signals passing through the QPSK receiver 125, the POD device 105, and the QPSK transmitter 120 shown in FIG. 2 are transmitted via an OOB interface (used as a return channel) having 12 signal pins. Accordingly, in the POD mode, a total of 60 signal pins are also required (such as in the PCMCIA mode) for information transaction between the conditional access system 100 and the POD device 105.

As mentioned above, it is wasteful that the conditional access system 100 uses so many signal pins in the PCMCIA and POD modes for booting up the POD device 105 and information transaction. This is because a chip size of the conditional access system 100 will be enlarged due to such many signal pins. That is, under this condition, the host 100 needs to reverse various interfaces for the POD device 105. Additionally, in another example, if the POD device 105 is replaced by another conditional access device (e.g. a DVB-CI device), the conditional access system 100 may not be able to communicate with the DVB-CI device by using the interfaces comprised of the above-mentioned signal pins. That is because PCMCIA, POD, DVB-CI interfaces have really different characteristics. Circuit designers need to design another conditional access system having different interfaces in order to comply with the DVB-CI standard.

### SUMMARY

It is therefore one of the objectives of the present invention to provide an apparatus and related method for accessing a conditional access device by bridging a specific communication interface and an external communication interface, to solve the above-mentioned problems.

According to an embodiment of the claimed invention, an apparatus for accessing a conditional access device, which utilizes an external communication interface for information transaction, is disclosed. The apparatus comprises a host and an interface module. The host is utilized for receiving or transmitting information according to a specific communication interface. The interface module is coupled to the host and utilized for bridging the specific communication interface and the external communication interface.

According to an embodiment of the claimed invention, an apparatus for accessing a conditional access device having a CPU interface is disclosed. The apparatus comprises a flash interface and a data processing circuit. The data processing circuit is coupled to the flash interface and utilized for receiving information outputted from the CPU interface through the flash interface or transmitting information to the CPU interface through the flash interface.

According to an embodiment of the claimed invention, an apparatus for accessing a conditional access device having an inband (INB) interface is disclosed. The apparatus comprises a serial interface and a data processing circuit. The data processing circuit is coupled to the serial interface and utilized for receiving data outputted from the INB interface through the serial interface or transmitting data to the INB interface through the serial interface.

According to an embodiment of the claimed invention, a method for accessing a conditional access device, which utilizes an external communication interface for information transaction, is disclosed. The method comprises: providing a specific communication interface; receiving or transmitting information according to the specific communication interface; and bridging the specific communication interface and the external communication interface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a prior art conditional access system when booting up a conditional access device.

FIG. 2 is a diagram of the prior art conditional access system when accessing the conditional access device.

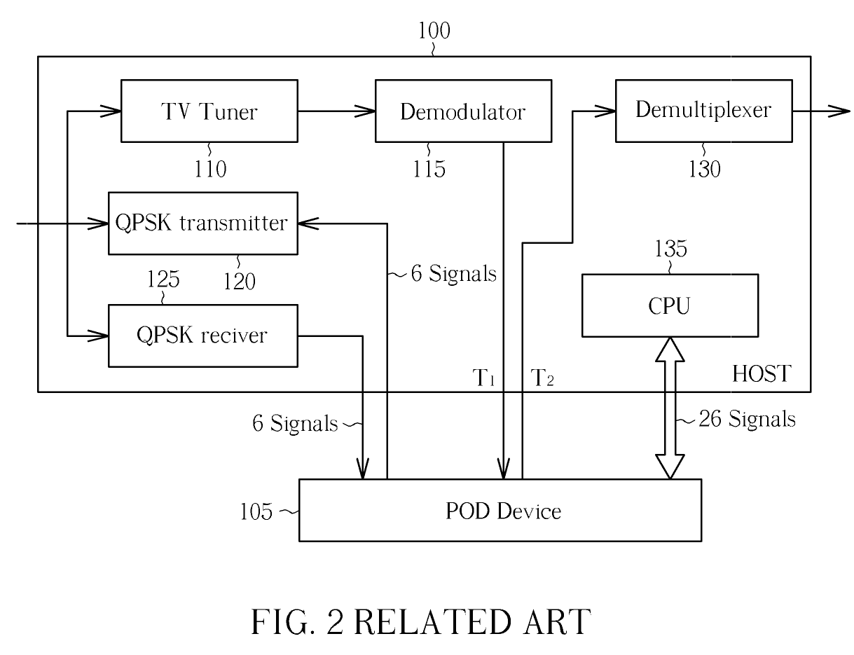

FIG. 3 is a diagram of an apparatus in PCMCIA mode according to an embodiment of the present invention.

FIG. 4 is a diagram of the apparatus shown in FIG. 3 in the POD mode.

FIG. 5 is a diagram showing an example of an interface module shown in FIG. 3 in POD mode.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

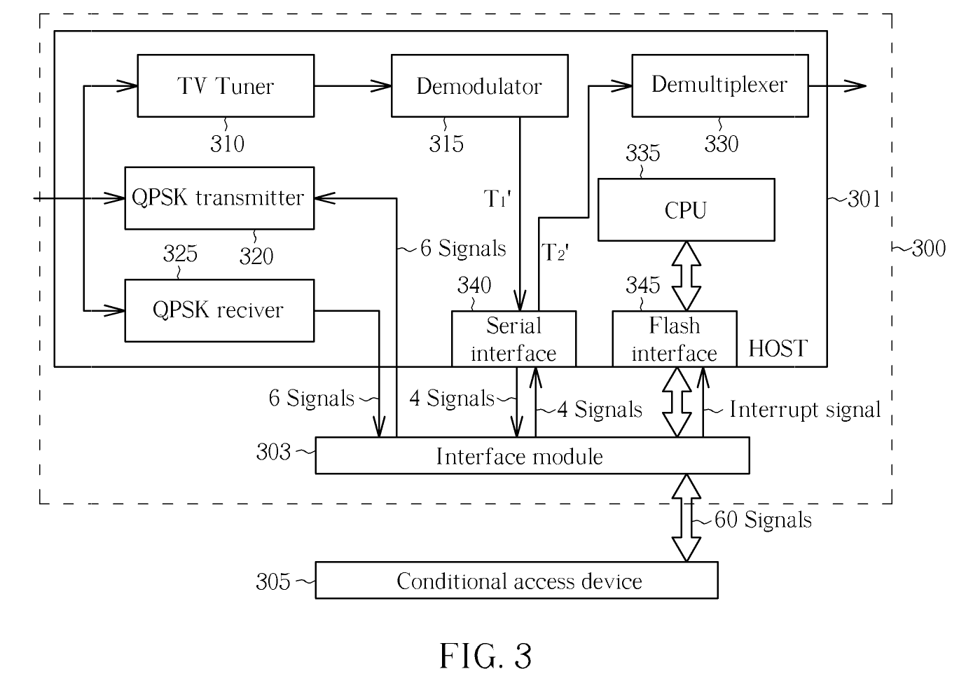

Please refer to FIG. 3. FIG. 3 is a diagram of an apparatus 300 in PCMCIA mode according to an embodiment of the present invention. The apparatus 300 includes a host 301 and an interface module 303; the apparatus 300 is utilized for accessing a conditional access device 305 (e.g. a POD device) using an external communication interface for information transaction. The host 301 includes a TV tuner 310, a demodulator 315, a QPSK transmitter 320, a QPSK receiver 325, a demultiplexer 330, a CPU 335, a serial interface 340, and a flash interface 345. In this embodiment, the serial interface 340 uses eight signal pins including two serial data pins, two clock pins, two sink pins, and two valid pins for signal transmission and reception respectively. The flash interface 345 is a NAND flash interface and it uses 14 signal pins for information transaction. Additionally, the host 300 further uses an interrupt signal pin for interrupting the CPU 335 when needed. When the apparatus 300 enters the PCMCIA mode, the CPU 335 boots up the conditional access device 305 through the flash interface 345, the interface module 303, and a PCMCIA interface having 60 signal pins. Under this condition, data or commands sent out by the CPU 335 are transmitted to the interface module 303 via the flash interface 345; the interface module 303 then converts the data or commands transmitted via the flash interface 345 into data or commands which can be transmitted via the PCMCIA interface. That is, the interface module 303 is utilized for bridging the flash interface 345 and the PCMCIA interface in the PCMCIA mode.

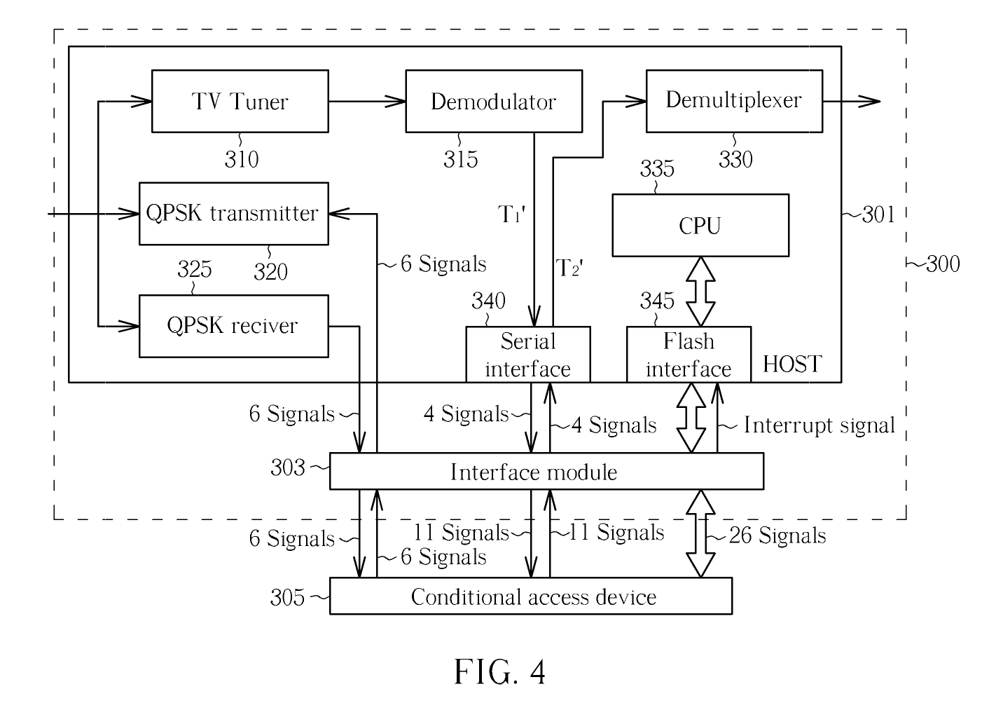

After the conditional access device 305 is started, the apparatus 300 enters POD mode. Please refer to FIG. 4. FIG. 4 is a diagram of the apparatus 300 shown in FIG. 3 in the POD mode. The demodulator 315 demodulates a received video program to generate a transport stream T₁′, and the transport stream T₁′ is then transmitted to the conditional access device 305 via the serial interface 340, the interface module 303, and a parallel interface (having 22 signal pins in total including sixteen parallel data pins, two clock pins, two sink pins, and two valid pins for signal transmission and reception respectively). In this case, the transport stream T₁′ transmitted to the interface module 303 via the serial interface 340 is converted by the interface module 303 into a transport stream, which can be transmitted to the conditional access device 305 via the parallel interface having 22 signal pins. After receiving the above-mentioned transport stream, the conditional access device 305 generates and outputs a corresponding transport stream to the interface module 303 via the parallel interface, and the interface module 303 converts the corresponding transport stream into a transport stream T₂′ which can pass through the serial interface 340. In addition, the host 301 can use the flash interface 345 to control the interface module 303 to set registers, to issue commands to the conditional access device 305, to transfer data between the CPU 335 and the conditional access device 305, and to use direct memory access (DMA) operation, etc. The above-mentioned interrupt signal pin can be used by the interface module 303 to interrupt the CPU 335 when a status of the conditional access device 305 is changed. Accordingly, by using the serial interface 340 and the flash interface 345, a size of the host 301 can be minimized. This is because the total number of signal pins used by the host 301 is lowered. It should be noted that a NAND flash read command and write command are often applied to achieve these operations described above; a description of how the NAND flash read command, write command, or another control command works is not detailed here since it is well-known to those skilled in this art.

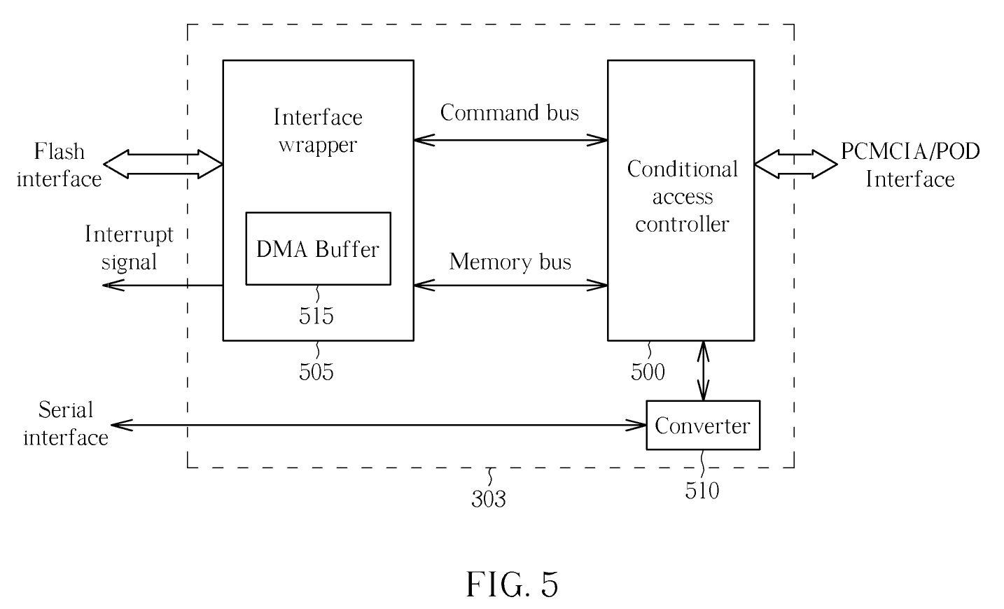

Please refer to FIG. 5. FIG. 5 is a diagram showing an example of the interface module 303 in POD mode. In this example, the interface module 303 includes a conditional access controller 500, an interface wrapper 505, and a converter 510. The conditional access controller 500 is utilized for controlling the conditional access device 305 shown in FIG. 3 through the PCMCIA interface or POD interface. The POD interface is comprised of the CPU interface, the INB interface, and the OOB interface, and both the PCMCIA and POD interfaces are referred to as communication interfaces external to the host 301. The interface wrapper 505 is utilized for delivering information received from the host 301 through the flash interface 345 to the conditional access controller 500 and for delivering information received from the conditional access controller 500 to the host 301 through the flash interface 345. For example, if the host 301 decides to write a single data into the conditional access device 305, the CPU 335 will configure the conditional access controller 500 by issuing a specific command or setting data through the flash interface. The interface wrapper 505 converts the specific command or setting data so that a converted specific command or converted setting data can be transmitted to the conditional access controller 500 via a command bus shown in FIG. 5. The CPU 335 triggers a single data write command to the conditional access controller 500 and then waits for an interrupt signal. If the CPU 335 receives an interrupt signal sent out by the conditional access controller 500, this means that the single data has been written into the conditional access device 305. Of course, a polling method can also be introduced to replace this interrupt method. This also obeys the spirit of the present invention. Otherwise, if the host 301 decides to read a single data from the conditional access device 305, the interface wrapper 505 will be utilized for delivering the single data (outputted from the conditional access device 305 and passing through the conditional access controller 500) to the CPU 335 via the flash interface 345 in addition to delivering commands or data into the conditional access controller 500 from the CPU 335. Moreover, the interface wrapper 505 further includes a DMA buffer 515 utilized for buffering a large amount of data when the DMA operation is enabled; of course, the DMA buffer 515 may be excluded from the interface wrapper 505 when the DMA operation is not provided by the apparatus 300. That is, the DMA buffer 515 is optional for the present invention.

Furthermore, the converter 510 is utilized for converting serial data (i.e. the transport stream T₁′) received from the host 301 through the serial interface 340 into parallel data (i.e. the above-mentioned converted transport stream), which is transmitted to the conditional access controller 500. The converter 510 also converts parallel data received from the conditional access controller 500 into serial data (i.e. the transport stream T₂′) that is transmitted to the host 301 through the serial interface 340. Further description is omitted here for the sake of brevity.

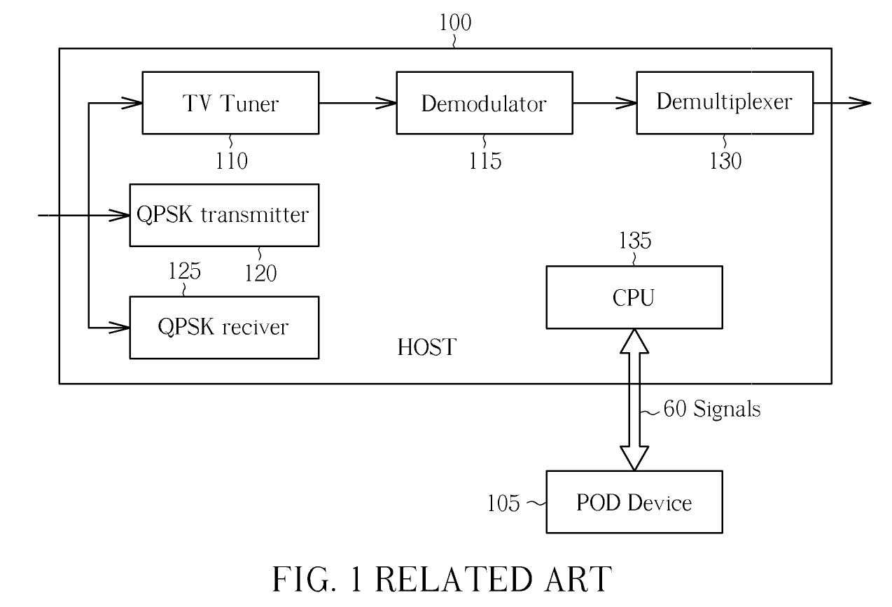

As mentioned above, it is obvious that communication interfaces (i.e. the OOB interface, the serial interface 340, and the flash interface 345) of the host 301 utilized for communicating with the interface module 303 to access the conditional access device 305 are never changed whether the host 301 is in PCMCIA mode or in POD mode. In other words, the host 301 is more easily implemented than the host 100 shown in FIG. 1. In particular, if the conditional access device 305 is a DVB-CI device instead of a POD device, it is only required to change realization of the interface module 303 without changing the host 301. That is, an advantage provided by the present invention is that designers only need to consider how to design the interface module 303 for accessing various conditional access devices when the host 301 is applied to conditional access. As mentioned above, a size of the host 310 can be reduced since a number of total signal pins corresponding to the communication interfaces of the host 301 is less than a number corresponding to the interfaces of the host 100.

Please note that, in this embodiment, the conditional access device 305 is a POD device; however, through the teachings of the present invention, the idea of the method of utilizing the interface module 303 for bridging an external communication interface and a specific communication interface can also be applied to accessing other conditional access devices, such as DVB-CI devices or smart cards, etc. Additionally, in other embodiments, the serial interface 340 and the flash interface 345 can be implemented separately. In other words, an apparatus, which only uses the serial interface 340 to replace an original parallel interface without replacing an original CPU interface by using the flash interface 345 (or only uses the flash interface 345 to replace the original CPU interface without replacing the original parallel interface by using the serial interface 340), also falls within the scope of the present invention. In addition, although the flash interface 345 of FIG. 3 is implemented by a NAND flash interface, it can also be implemented by other communication interfaces, such as a NOR flash interface or a serial flash interface, etc. Furthermore, in another embodiment, since the interface module 303 may be integrated within the conditional access device 305, designers can just provide the host 301 (i.e. an apparatus including a specific communication interface such as the serial interface 340 or the flash interface 345 and a data processing circuit composed of other circuit units within the host 301), to access the conditional access device 305. These modifications all obey the spirit of the present invention.

Those skilled in the art will readily observe that numerous modifications and alterations of the device and method may be made while retaining the teachings of the invention.

What is claimed is:

1. An apparatus for accessing a conditional access device, the conditional access device utilizing an external communication interface for information transaction, the apparatus comprising:
a host, for receiving or transmitting information according to a specific communication interface; and
an interface module, coupled to the host, for bridging the specific communication interface and the external communication interface.

2. The apparatus of claim 1, wherein the specific communication interface is a flash interface.

3. The apparatus of claim 2, wherein the external communication interface is a CPU interface.

4. The apparatus of claim 1, wherein the interface module comprises:
a conditional access controller, for controlling the conditional access device through the external communication interface; and
an interface wrapper, coupled to the specific communication interface and the conditional access controller, for delivering information received from the host through the specific communication interface to the conditional access controller or delivering information received from the conditional access controller to the host through the specific communication interface.

5. The apparatus of claim 1, wherein the apparatus is configured to access the conditional access device being a POD device.

6. The apparatus of claim 1, wherein the apparatus is configured to access the conditional access device being a DVB-CI device.

7. The apparatus of claim 1, wherein the specific communication interface is a serial interface, and the external communication interface is a parallel interface.

8. The apparatus of claim 7, wherein the external communication interface is an inband (INB) interface.

9. The apparatus of claim 7, wherein the interface module comprises:
a conditional access controller, for controlling the conditional access device through the external communication interface; and
a converter, coupled to the specific communication interface and the conditional access controller, for converting serial data received from the host through the specific communication interface into parallel data transmitted to the conditional access controller, or converting parallel data received from the conditional access controller into serial data transmitted to the host through the specific communication interface.

10. An apparatus for accessing a conditional access device, the conditional access device having a CPU interface, the apparatus comprising:
a flash interface; and
a data processing circuit, coupled to the flash interface, for receiving information outputted from the CPU interface through the flash interface or transmitting information to the CPU interface through the flash interface.

11. The apparatus of claim 10, wherein the apparatus is configured to access the conditional access device being a POD device.

12. The apparatus of claim 10, wherein the apparatus is configured to access the conditional access device being a DVB-CI device.

13. An apparatus for accessing a conditional access device, the conditional access device having an inband (INB) interface, the apparatus comprising:
a serial interface; and
a data processing circuit, coupled to the serial interface, for receiving data outputted from the INB interface through the serial interface or transmitting data to the INB interface through the serial interface.

14. The apparatus of claim 13, wherein the apparatus is configured to access the conditional access device being a POD device.

15. The apparatus of claim 13, wherein the apparatus is configured to access the conditional access device being a DVB-CI device.

16. A method for accessing a conditional access device, the conditional access device utilizing an external communication interface for information transaction, the method comprising:
providing a specific communication interface;
receiving or transmitting information according to the specific communication interface; and
bridging the specific communication interface and the external communication interface.

17. The method of claim 16, wherein the step of providing the specific communication interface comprises:
utilizing a flash interface as the specific communication interface; and
the step of bridging the specific communication interface and the external communication interface comprises:
receiving information outputted from the external communication interface through the flash interface or transmitting information to the external communication interface through the flash interface.

18. The method of claim 16, wherein the step of providing the specific communication interface comprises:
utilizing a serial interface as the specific communication interface; and
the step of bridging the specific communication interface and the external communication interface comprises:
receiving data outputted from the external communication interface through the serial interface or transmitting data to the external communication interface through the serial interface.
